(19) United States
(12) Patent Application Publication
(10) Pub. No.: US 2003/0014461 A1
(43) Pub. Date: Jan. 16, 2003

(54) Client control system for routine task

(75) Inventor: yasuoki Tanaka, Tokyo (JP)

Correspondence Address: Jordan and Hamburg LLP, 122 East 42nd Street, New York, NY, 10168, US

(73) Assignee: AXIS Software Co., Ltd.

(21) Appl. No.: 09/758,929

(22) Filed: Jan. 11, 2001

(51) Int. Cl. G06F 9/00; G06F 15/16

(52) U.S. Cl. 709/100; 709/203

(57) ABSTRACT

In a client control system for the routine task in a wide area network for managing data in a centralized manner by a server, to provide a client control system for the routine work which is capable of conducting client processing having an excellent response with respect to various input/output processing without requiring any individual maintenance load.

A client control system 1 for routine task comprises a client control unit 4 including an input/output managing unit 14 for conducting the input/output processing of the routine form on the side of clients, in various modes of display on screen, key entry, printer with respect to object data which is to be input/output processed and to be registered and managed in a server, and a data exchange control unit 5 for data-exchanging and processing the request and response of processing between the clients and the server for controlling the clients by means of cache control. Said processing response is separated into an input/output definition command for routinely input/output processing by means of said input/output managing unit 14 and a data definition command for defining an object data, and said client control unit 4 comprises an object data managing unit 15 for sharing and managing said object data in such a manner that reference and update of the object data for each item thereof is enabled in response to the data definition command.

### BACKGROUND OF THE INVENTION

1. Field of the Invention

The present invention relates to a client control system for routine task in a wide area network for managing data in a centralized manner by means of a server and in particular to a client control system for routine task which enables client processing having an excellent response to various input/output processing without requiring any individual maintenance loads.

2. Description of the Prior Art

A world wide web (WWW) system is known as a wide area network system for managing data in a centralized manner by means of a server. The WWW system is excellent in information sharing and is suitable for centralized management of information.

When the WWW is applied to the routine task processing which is mainly conducted by the input of the clients in a wide area network, it is disadvantageous in the ease of operation since the rate of the communication line between the server and the clients is a bottleneck. The WWW system is inevitably disadvantageous since considerable cost for facility for the high rate line is required in order to compensate for the low rate of the communication line.

An approach to solve the problem is to construct a network system so that a task processing software is provided to each of the clients to suppress the data communication between the server and the clients to a minimal limit for assuring the response of the task processing.

However, the above-mentioned network system requires maintenance for individual task processing software which is distributed to clients since it is necessary to provide task processing software which is relevant to a lot of clients which are in different circumstances. Accordingly, in a large scale wide area network, a problem occurs in that large load of maintenance is inevitable in the whole of the network.

### SUMMARY OF THE INVENTION

It is an object of the present invention to provide a client control system for routine task in a wide area network for managing data in a centralized manner by means of a server, which enables client processing having an excellent response to various input/output processing without requiring individual maintenance load.

In order to accomplish the above-identified object, in a client control system for routine task comprising a client control unit including an input/output managing unit for conducting the input/output processing of the routine form on the side of clients, in various modes of display on screen, key entry, printer with respect to object data which is to be input/output processed and to be registered and managed in a server, and a data exchange control unit for data-exchanging and processing the request and response of processing between the clients and the server for controlling the clients by means of cache control, said processing response is separated into an input/output definition command for routinely input/output processing by means of said input/output managing unit and a data definition command for defining an object data, and said client control unit comprises an object data managing unit for sharing and managing said object data in such a manner that reference and update of the object data for each item thereof is enabled in response to the data definition command.

The client control system for the routine task is formed so that cache control is enabled by separating the processing response from the server into an input/output definition command and a data definition command. Accordingly, the input/output definition command which is repetitive when the client control unit conducts processing based upon the processing response can be obtained from the cache. Communication with server can be minimized so that response of processing of the routine task can be assured even if using a low rate communication line. Since the object data management unit shares and manages the object data for each item in response to various data definition commands and the input/output managing unit conducts the input/output processing of the object data in response to the input/output definition command, input definition of various indication modes which are common in the object data is made possible. The input/output processing in various modes can be conducted on the side of client.

The operation definition which defines the operation processing between the items of the object data is included in the input/output definition command. The object data operating unit which conducts the operation processing between the items of the object data in accordance with the operation definition is provided. Since the object data operating unit conducts the operation processing between the items of the object data based upon the operation definition in the input/output definition command, the relation between the items is maintained even if the object data is changed by the input/output processing for the addition and update. The input/output processing in which a result of the change is reflected on the indication is made possible by the independent processing on the side of client.

The client control unit includes the dependence relation managing unit for rearranging the operation order depending upon the dependence relationship between the data items based upon the operation definition. Operation processing can be efficiently conducted by forming the object data operating unit so that it conducts the operation in accordance with the rearranged order. Accordingly, the response of input/output processing for addition and update can be assured.

### BRIEF DESCRIPTION OF THE DRAWINGS

FIG. 1 is a functional and structural view showing the client control system for the routine task of the present invention;

FIG. 2 is an explanatory view showing an exemplary data structure of the indication control data which is dealt by the data structure managing unit;

FIG. 3 is an explanatory view showing the content of the intermediate data which is associated with the processing when the data is changed;

FIG. 4 is a process view showing the input/output definition command;

FIG. 5 is a process view showing the data definition command;

FIG. 6 is a graph showing the relation between the response processing speed and the number of repetitions.

### DETAILED DESCRIPTION OF THE PREFFERRED EMBODIMENTS

An embodying mode in which the technical concept constitutes the solving means will now be described with reference to the drawings.

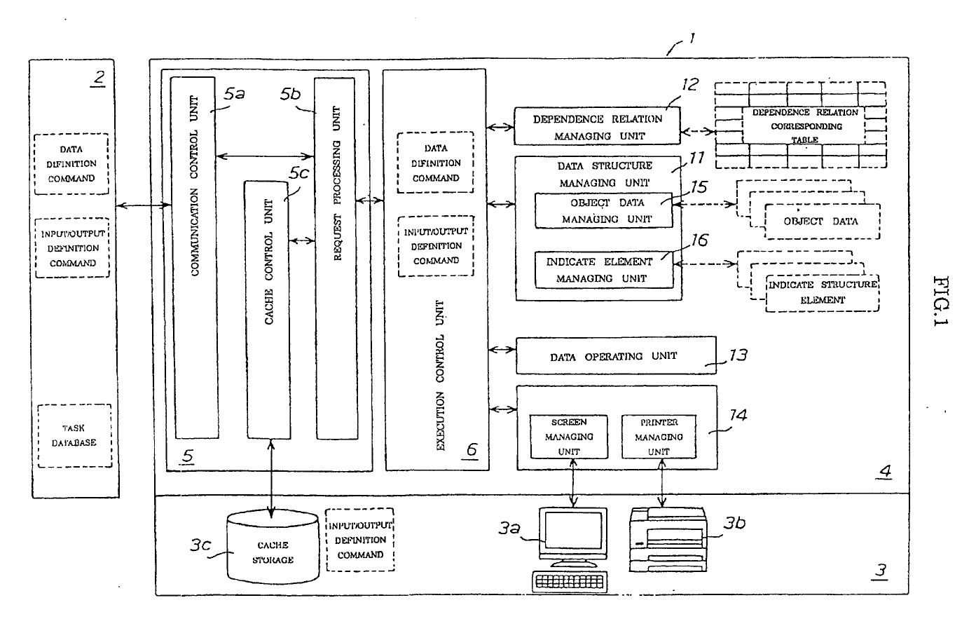

FIG. 1 is a structural view showing the functions of the client control system for routine task of the present invention. The client control system for the routine task 1 is connected to the server 2 over a communication line. The server 2 constitutes a wide area network which manages the data in a centralized manner. The structure of the server 2 comprises a device group 3 for data exchange and input/output and a client control unit 4 which controls the device group 3 in a centralized manner.

Specifically, the device group 3 includes a keyboard and a mouse for the entry of data and further includes input/output devices including a display 3a, for displaying the data on a screen such as CRT, LCD display, and various printers 3b for outputting sheet such as slips for bar code and a cache storage 3c for assisting the data exchange and the other appropriate devices if necessary.

The client control unit 4 comprises a data exchange unit 5 for managing the data exchange processing which is requested from and responded to the server 2, and an indication processing unit for managing the input/output devices such as display 3a and printer 3b, and for dealing the intermediate data therefor.

The above-mentioned data exchange unit 5 comprises a communication control unit 5a, request processing unit 5b and a cache control unit 5c, etc. The communication control unit 5a performs the network communication control between the data exchange unit 5 and the server 2. The request processing unit 5b receives and transmits the processing request and processing response from and to the server 2 via the communication control unit 5a. At this time, the request processing unit 5b obtains the processing response from the cache storage 3c preferentially depending upon the content of the processing request. The cache control unit 5c cache-processes the processing response which is to be conducted by the cache storage 3c.

In order to enhance the cache efficiency, the above-mentioned processing response is individually dealt with by separating it into the input/output definition command and the data definition command. The input/output definition command defines the routine processing depending upon the input/output modes. The data definition command defines the object data which is managed in a centralized manner by the server and to be input/output processed.

Additionally, the above-mentioned request processing unit 5b generates a registration request command which requests the registration of the object data depending upon the job specification and sends it to the server for registering the updated object data in the server to manage it in the server in a centralized manner.

The above-mentioned indication processing unit excepting the data exchange unit 5 comprises a execution control unit 6 and a group of versatile processors which are classified by their functions, which are controlled by the execution control unit 6. The execution control unit 6 receives and transmits the processing request and processing response from and to the data exchange unit 5 depending upon the content of the job, and controls the group of processors which are classified by their functions depending upon the job content. The group of the processors which are classified by their functions is controlled by the execution control unit 6 and take part for various indication processing for the input/output processing.

The group of processors which are classified by their functions comprises a data structure managing unit 11 for generating indication control data defining the mode of the indication for the input/output based upon the input/output definition command and the data definition command, a dependence relation managing unit 12 for managing the dependence relationship between the items of the object data based upon the data definition command, an object data operating unit 13 for operating each item of the object data in accordance with the dependence relationship, an input/output control unit 14 for managing the operation of the input/output devices such as display 3a and printer 3b based upon the display control data. Each unit comprises a versatile data processor for conducting the processing in response to the command.

The data structure managing unit 11 coordinates the structure of the indication control data which corresponds to various indicate forms of table and graph and various indicate modes of display screen, sheet print. At this end, the data structure managing unit 11 comprises the object data managing unit 15 and the indication element managing unit 16.

The object data managing unit 15 mainly generates the structure item of the object data based upon the input/output definition command and sets the substantial data in the structure item of the object data based upon the data definition command for defining its content, shares and manages the object data in such a manner that reference and update can be conducted in unit of data item which is necessary for the indication control. The display element managing unit 16 forms a component object which constitutes the form element and the data item element of various input/outputs which are the constitutional elements of the input/output forms and the object data based upon the input/output definition command and generates the indication constitutional elements of the display control for the input/output and shares and manages the data in such a manner that reference is possible in unit of element.

The object data is mainly defined by the data definition command which is generated based upon a task data base which is registered in the server for forming a data group which is in a given form which is determined by a business logic depending upon the job. Since various indication modes can be prescribed by combining the data object with the indication constitutional elements, various indication modes can be defined in a multiplexing manner by making the object data common.

Processing can be completed on the side of client by defining various indication modes depending upon the indication form of entry table and evaluation graph and the kind of media such as display screen and print while the indication in various modes using data entry working and update data does not require the support by the server. The updated object data will become a target of the processing request of the data registration for the purpose of the server registration.

The dependence relation managing unit 12 has a sorting function for generating a dependence relation corresponding table including structure elements of an operation calculation equation between the items of the object data based upon the item operating definition in the input/output definition command and for rearranging the dependence relation corresponding table in accordance with the order of the dependence relation between the items. The items of the object data which depends upon the other data items in addition to the transfer of the data is compensated for by the data operating unit conducting an operation upon the operating computing equation which has been rearranged by the sort function. This is indicated by the input/output managing unit 14. The same is applied to the data update.

Now, the data structure of the indication control data will be described. The indication control data comprises a combination of the indication elements with the object data and its link and defines various indication modes by defining the content of the structure via a node which forms a pointer for indicating the link relation therebetween.

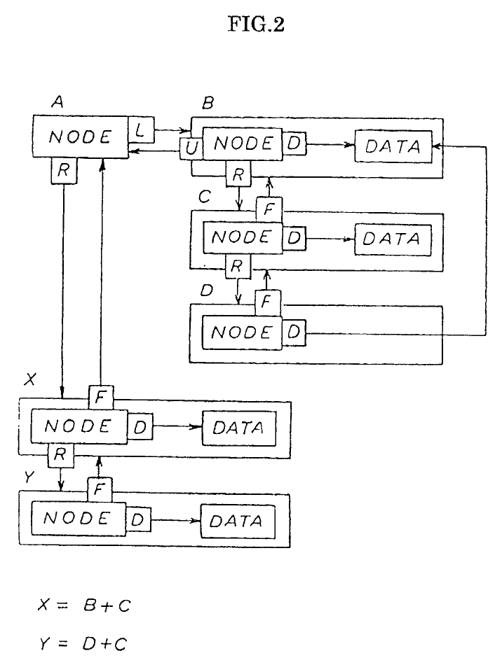

FIG. 2 is a diagram explaining an exemplary data structure of the indication control data which is dealt by the data structure managing unit.

The node is a pointer which is representative of the link relation between the items. Each node has a pointer which points a lower position L, front position P and rear position M, and a data pointer D which points substantial data if it is a data node. The substantial data has a reference count, change count, etc.

In the illustrated example, a structure is shown in which the item B is transferred to the item D and is used. A change in one substantial data is always reflected on the other substantial data by the multiple definition to set the data pointer of the item B on the data pointer of the item D. The items X and Y are linked with a group A including the items B, C, D by the pointer pointing the front position P and the rear position M in accordance with the operation definition representing a calculating equation between the items. A calculation is conducted by using the substantial data which is taken by the link relation. A result of the calculation is stored in the data pointer position which is pointed by the items X and Y. Common use from all reference sources is made possible by the other plural indication elements referencing the sorted result.

Accordingly, since the portion which is common in the indication form and the object data can be commonly dealt by the instruction of the pointer, the result can be reflected on all indication modes particularly when the object data is updated.

Since various indication forms of table and graph which are dealt by the data structure managing unit are common in its object data in the range of one task processing and are often common even if there is a difference in the indication mode of display screen and sheet printing, the above-mentioned indication control data can exclude the disturbance of the mutual coalition due to individual dealing by defining the content by the hierarchial structure in which combination of the data in any number of layers is possible the other node.

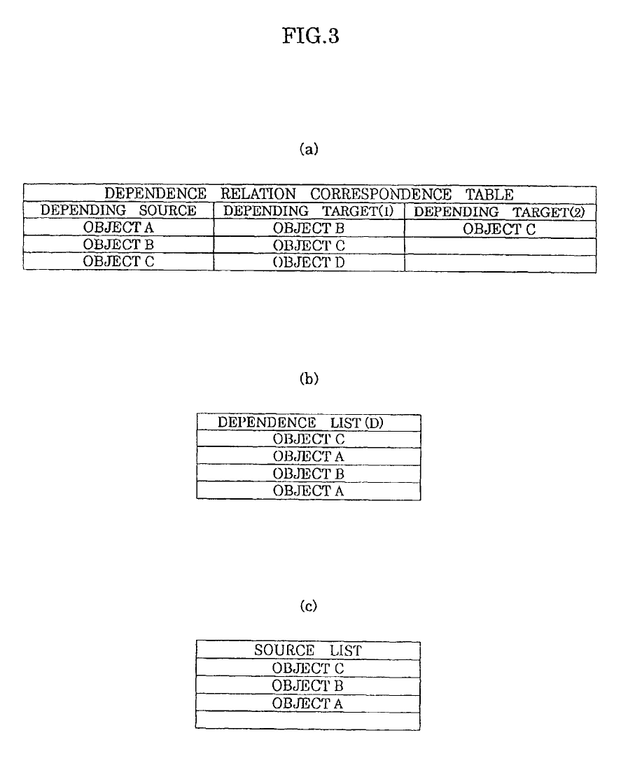

FIG. 3 is a diagram explaining the content of the intermediate data which is associated with the processing when the data is changed.

The dependence relation corresponding table in FIG. 3(a) is a table in which the items of the dependence source of the operation items which is defined by the operation definition, that is the element items which constitute the operating equation of each operating item are arranged. The operating equation is preset in a table cell which forms each data item of the object data.

If the item D which is the dependence target item of the item C which is defined by the operating equation is changed, the item which is subjected to the change will be picked up in accordance with the dependence relation corresponding table and the item which will be subjected to is registered in the dependence list in FIG. 3(b). In other words, the changing item C in which the changing item D is the dependence target is picked up by searching the dependence target in the dependence relation corresponding table.

Subsequently, the item which will be subjected to the change by the picked up item C is picked up and is similarly registered in the dependence list. By repeating this process, all changing items are picked up as the dependence list (D) concerning to the item D.

When the above-mentioned dependence list (D) has been formed, the duplicated items are arranged and are registered in the sort list in FIG. 3(c) while rearranging the dependence list (D) in accordance with the dependence relation of the dependence relation corresponding table. The result of change can be efficiently reflected on the related target which will cause the change while preventing wasteful calculation by conducting the calculation of the operating equation in the order of the sort list.

The whole operation of the client control system for the routine task, the function and structure of which has been described will be described.

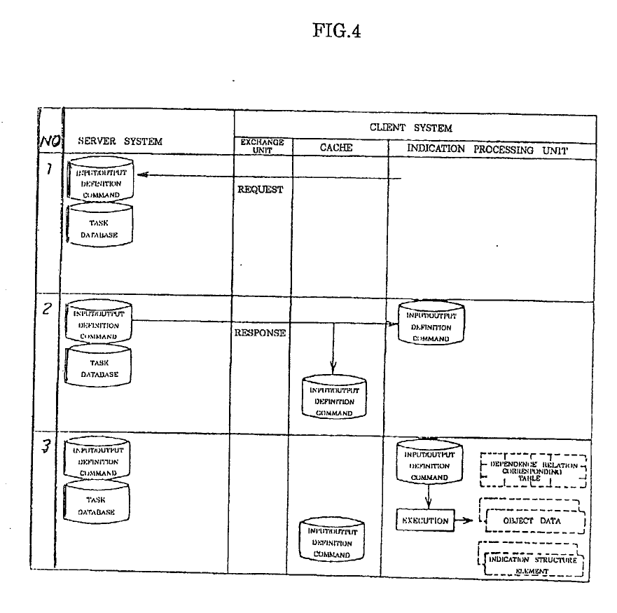

FIG. 4 is a chart showing a process of the input/output definition command.

A processing request corresponding to the specified job which is selected by the system menu is transferred from the indication processing unit to the data exchange unit including communication control unit and a cache. The processing request can be conducted by the cache by individually requesting the input/output definition command and the data definition command, and can avoid the repeating of the communication of the input/output definition command having a large quantity of data and can achieve the reduction in the load on the server and the distribution of the load.

If there is no input/output definition command in the cache, a processing request is made so that the input/output definition command is to be received from the server (step 1). The client receives the corresponding processing response and the processing response is registered in the cache (step 2). If there is the input/output definition command is in the cache, the input/output definition command is received from the cache, and the received input/output definition command is developed to the dependence relation corresponding table, object data, indication structure element, etc. by the execution control unit (step 3). The indication control data representative of various modes such as indication form of table and graph and indication mode of display screen and print is generated from the indication structure elements and object data in accordance with the input/output definition command.

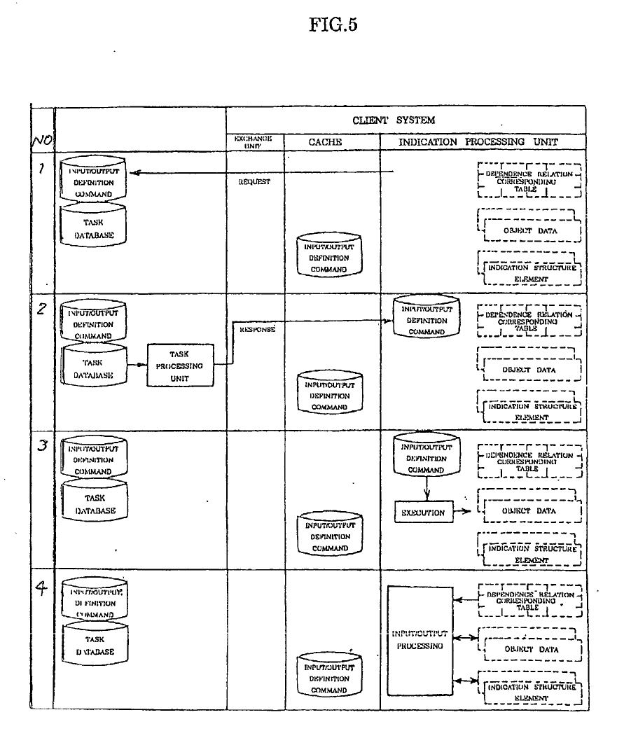

FIG. 5 is a diagram showing the process of the data definition command.

After completion of the processing of the input/output definition command, processing request is made to receive the data definition command from the server (step 1). The data definition command is generated so that it is taken from the data base by the task processing logic depending upon the job content for defining the object data which is to be input/output and is then transferred to the client as the processing response (step 2). Preparation of the indication control data for the input/output is completed by setting of the content in the object data in accordance with the received data definition command (step 3).

The object data which has been changed by the dependence relation processing can be reflected on the various outputs if data entry is conducted via the display and keyboard, etc. Managing material of the evaluation graph and table form including revised data is displayed and printed in accordance with the output instruction (step 4). These outputs can be efficiently conducted by the inner processing on the side of client without receiving the assistant of the server.

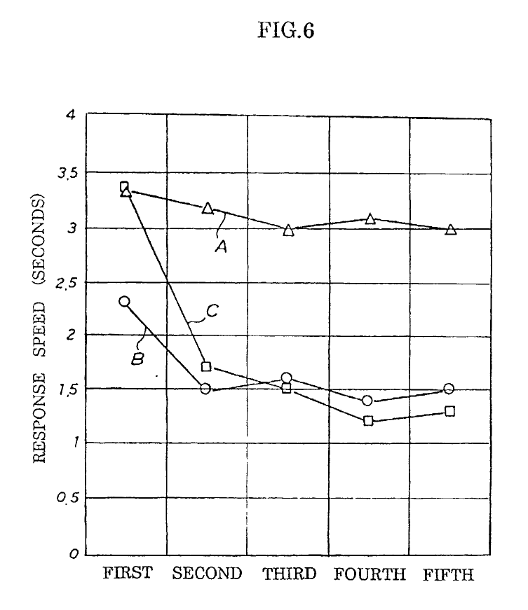

FIG. 6 is a graph showing the relation between the speed of response operation and the number of repetitions.

When a WWW system A is used, no large change occurs since the response is determined by the communication rate between the system and the server even if the same task processing is repeated. When a devoted system B which is installed into the client is used, an excellent response can be obtained. When the present system C is used, although there is an influence of the communication rate at the first time, the excellent response can be obtained similarly to the devoted system B since the communication rate is suppressed at the second time and thereafter.

Since the present system deals the separated indication manner and the data structure as mentioned above, it is capable of enhancing the productivity in the system adjustment as well as the above-mentioned response since it can easily cope with the utilization mode and the indication capacity of the terminal.

The client control system for routing task of the present invention has advantages as follows.

The client control system for the routine task is formed so that cache control is enabled by separating the processing response from the server into an input/output definition command and a data definition command. Accordingly, the input/output definition command which is repetitive when the client control unit conducts processing based upon the processing response can be obtained from the cache. Communication with server can be minimized so that response of processing of the routine task can be assured even if using a low rate communication line.

Since the object data management unit shares and manages the object data for each item in response to various data definition commands and the input/output managing unit conducts the input/output processing of the object data in response to the input/output definition command, input definition of various indication modes which are common in the object data is made possible. The input/output processing in various modes can be conducted on the side of client.

Therefore, the above-mentioned client control system for the routine task is capable of assuring excellent response of the input/output without requiring any high rate communication line by means of and of coping with the indication processing of the input/output in various modes without requiring any loads of individual maintenance which is imposed on the client.

3. A client control system for routine task as defined in claim 2 characterized in that said client control unit comprises an dependence relation managing unit for rearranging the order of operations depending upon the dependence relations between the data items based upon the operation definition, whereby said object data operating unit conducts the operations in accordance with the rearranged order.
